(19) United States
(12) Patent Application Publication
(10) Pub. No.: US 2022/0397181 A1
(43) Pub. Date: Dec. 15, 2022

(54) Links and Chains

(71) Applicant: George Terah Gough, Staffordshire (GB)

(72) Inventor: George Terah Gough, Staffordshire (GB)

(21) Appl. No.: 17/755,155

(22) PCT Filed: Oct. 22, 2020
(86) PCT No.: PCT/GB2020/052655

§ 371 Date: Apr. 22, 2022

(30) Foreign Application Priority Data
Oct. 25, 2019 (GB) 1915482.2

(51) Int. Cl. F16G 13/18; F16G 15/12; F16G 13/06

(52) U.S. Cl. CPC F16G 13/18; F16G 15/12; F16G 13/06

(57) ABSTRACT

A link (2) for a chain (1), and a chain (1) of links (2), the link (2) comprising a body defining first and second parallel through bores (4) separated by a length, in which the body has a first width (d1) perpendicular to the length over at least a portion of the body adjacent to each bore (4) and a second width (d2) through each bore (4) parallel to the first width (d1) and perpendicular to the length, in which the first (d1) and second (d2) widths are different. The links (2) may be joined by joints (3), each joint (3) joining a pair of successive links (2), each joint (3) comprising a body (5a, 5b) and two shafts (6), the body (5a, 5b) supporting the two shafts (6), with each shaft (6) engaging the first bore (4) of one of the pair of links (2) and the second bore (4) of the other of the pair of links (2), the joint (3) being arranged such that it can rotate relative to each of the of the pair of links (2) about the shaft (6) which engages each link (2).

This invention relates to links and chains.

Typically, chains have been formed from a succession of joined loops, or by rigid members joined by pivoting shafts (as in a bicycle chain). However, whilst the behaviour of such chains is predictable in tension, it is less so in compression.

In some belt or chain environments, it is useful to be able to vary the pitch of the chain or belt, as described in the PCT patent application published as WO2011/128678, which uses a belt formed of metal plates which slide over each other. Such environments include bucket conveyors, where it is desirable to have the buckets close together on loading, so that the contents do not fall between the buckets, but spaced apart elsewhere, so the buckets do not collide.

According to a first aspect of the invention, there is provided a link for a chain, the link comprising a body defining first and second parallel through bores separated by a length, in which the body has a first width perpendicular to the length over at least a portion of the body adjacent to each bore and a second width through each bore parallel to the first width and perpendicular to the length, in which the first and second widths are different.

This arrangement allows the pitch between links to be controlled if the distance between adjacent bores on successive links is kept constant; the relative first and second widths controlling the pitch when the links are collapsed on top of one another.

The link may have the first width over the body except around each bore, and as such the portion of the body having the first width may have a consistent cross section along the length. Each bore may be cylindrical, having an axis. The body may have an enlarged section around each bore having a part-cylindrical outer surface coaxial with the bore, with the second width being the diameter of the enlarged section.

Alternatively, the first width may be present only over part of the link, and may comprise a protrusion from the body. This reduces the amount of material necessary to form the link. As such, the body of the link may have a width that is a maximum of a third width, narrower than the first or second widths, over at least part of the link. The body of the link may have the width that is a maximum of the third width over a majority of the length of the link. The protrusion may extend only over a portion of the depth of the link, perpendicular to the length and width of the link; typically, the portion of the depth of the link may be less than two thirds or a half of a maximum depth of the link.

According to a second aspect of the invention, there is provided a chain, comprising a plurality of links in accordance with the first aspect of the invention, the links being joined successively in a chain, and a plurality of joints, each joint joining a pair of successive links, each joint comprising a body and two shafts, the body supporting the two shafts, with each shaft engaging the first bore of one of the pair of links and the second bore of the other of the pair of links, the joint being arranged such that it can rotate relative to each of the of the pair of links about the shaft which engages each link.

This mounting arrangement, in combination with the varying width of the link, allows for the effective length of each pair of links to be varied by rotating the joint relative to the links. Typically, the links would be identically shaped.

Each joint may have a first position relative to the pair of links in which an effective length being the distance between the first bores of each of the pair of links is maximised and a second position where the effective length is minimised, with rotation of the joint relative to each of the pair of links effecting a transition between the first and second positions. The first position may be with the lengths of the pair of links co-linear. The second position may be with a portion of the first link of the first width touching a portion of the second link with the second width (typically the enlarged section) and with a portion of the first link of the second width (typically the enlarged section) touching a portion of the second link with the first width. Thus, the first and second widths therefore control the minimum effective length.

Typically, the chain may be arranged such that placing a portion of the chain comprising a plurality of links in tension tends to cause joints in that portion to assume the first position and/or that placing a portion of the chain comprising a plurality of links in compression tends to cause joints in that portion to assume the second position. Thus, the pitch of the chain can be varied in a controlled fashion depending on whether it is in tension or compression.

The shafts of each link will typically be parallel. However, the shafts of each link may be mounted in the body so as to pivot about at least one, and typically two, axes perpendicular to each shaft over a range of angles including the position where the shafts of each link are parallel. The range may be at least 90, 120, 150 or 180 degrees. This can allow the chain to pass around corners.

At least one of the joints may comprise a trunnion by means of which the chain can be driven along its length. The trunnions may be arranged such that they can provide compression or tension to the chain in order to change the pitch of the chain.

The body of each joint may comprise a bore for each shaft. The body may be generally cylindrical in shape having a curved outer surface, but may have a deviation from cylindrical by means of which the joint can be rotated relative to its links. The deviation may comprise at least one depression into (or protrusion from) the curved outer surface.

The body may be provided with a load plate having a bore for each shaft, positioned in the body such that each shaft passes through a bore in the body and the load plate, and such that any compressive or tension load in the chain is passed between the shafts preferentially or entirely through the load plate rather than the body. Typically, the load plate will be made of a stronger (in terms of at least one of tensile strength and compressive strength) material than the body. For example, the body may be formed of a plastics material, whereas the load plate may be formed out of a metal material such as steel.

There now follows by way of example only description of an embodiment of the invention described with reference to the accompanying drawings, in which:

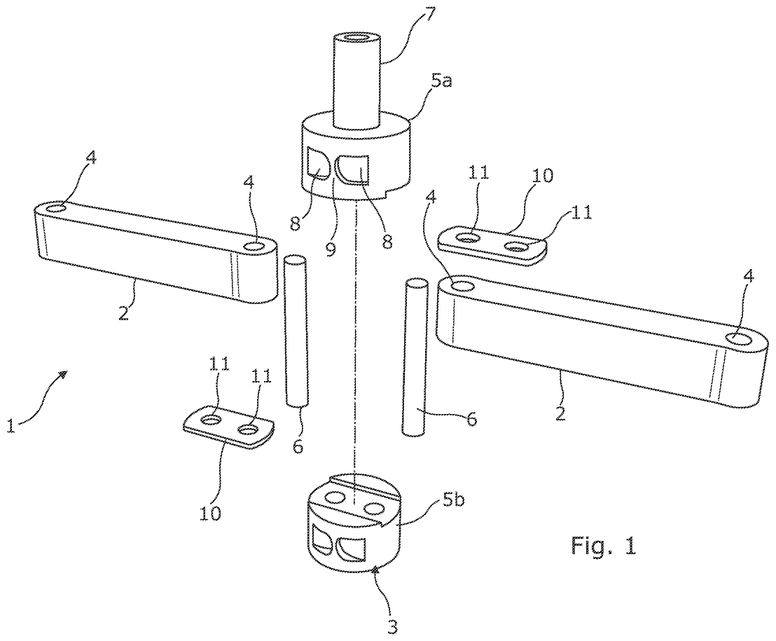

FIG. 1 shows an exploded view of a joint and two links of a chain in accordance with a first embodiment of the invention;

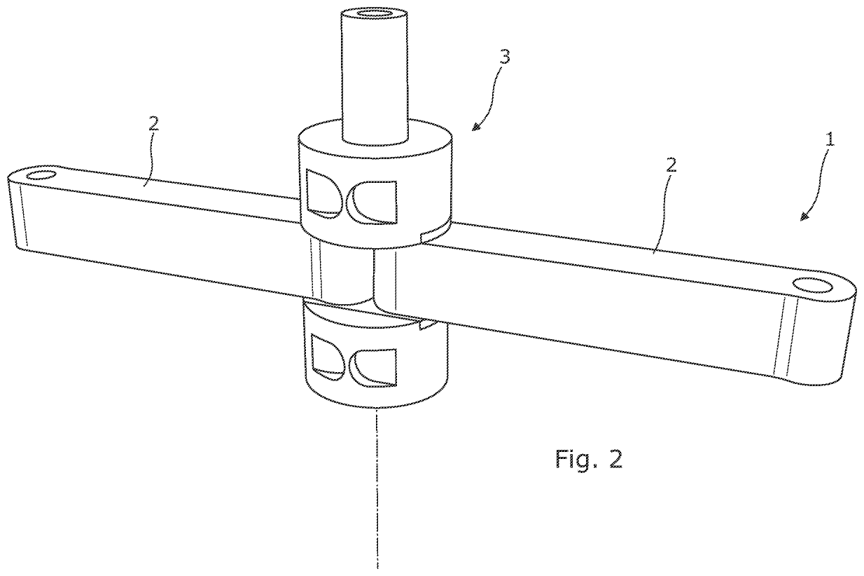

FIG. 2 shows a perspective assembled view of the joint and two links of FIG. 1;

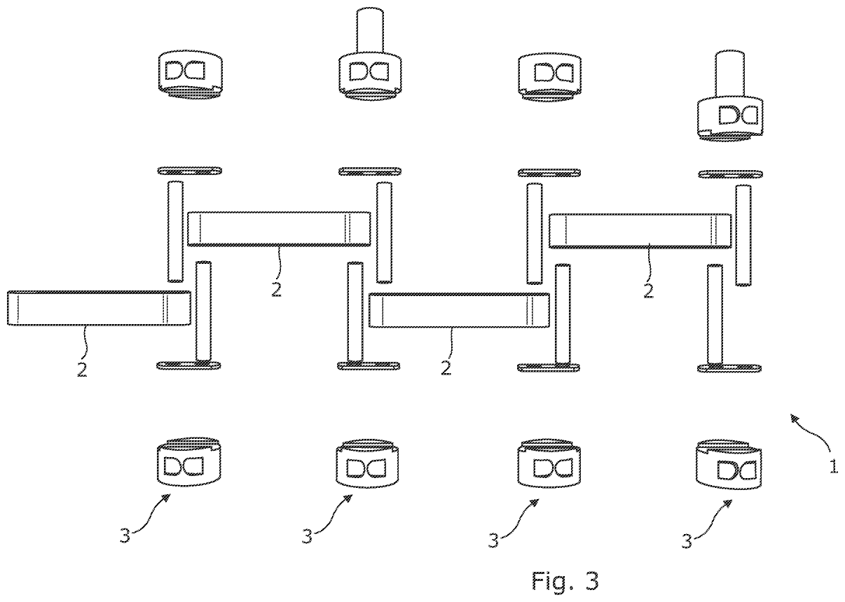

FIG. 3 shows an exploded view of the chain of FIG. 1;

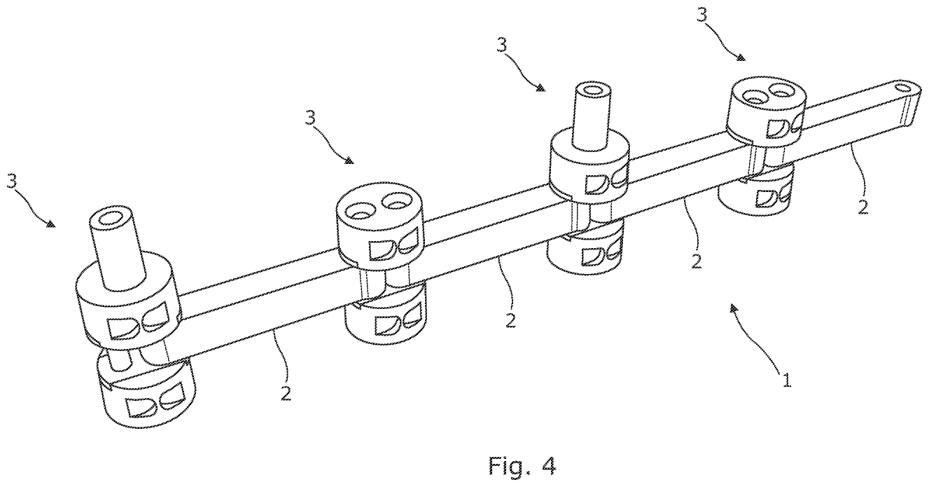

FIG. 4 shows an assembled view of the chain of FIG. 1;

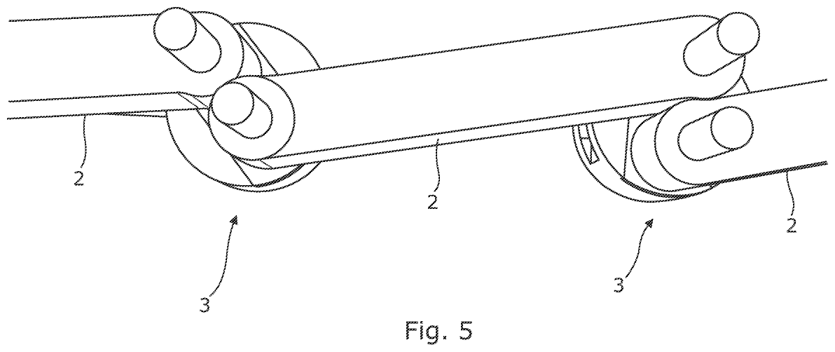

FIG. 5 shows a partially exploded view of the chain of FIG. 1, showing the chain as the joints rotate to allow the chain to collapse;

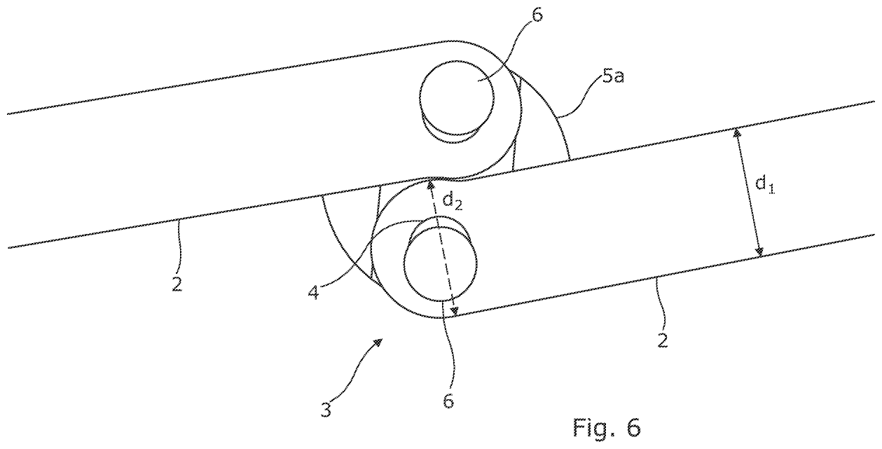

FIG. 6 shows an enlarged version of FIG. 5 as rotation of the joints continues;

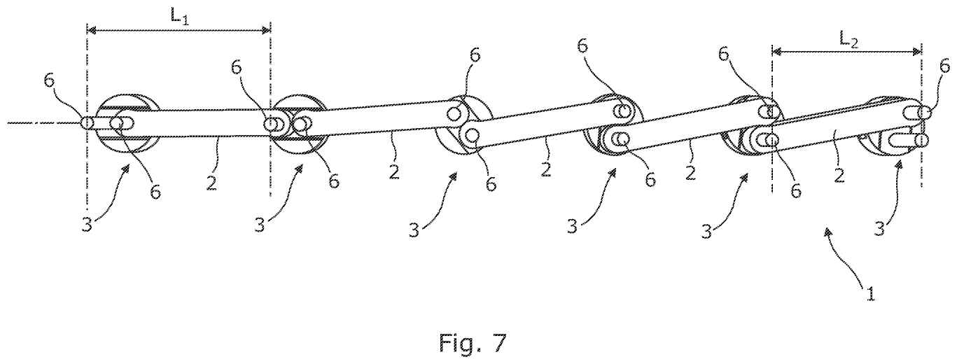

FIG. 7 shows the chain of FIG. 1 in varying levels of joint rotation;

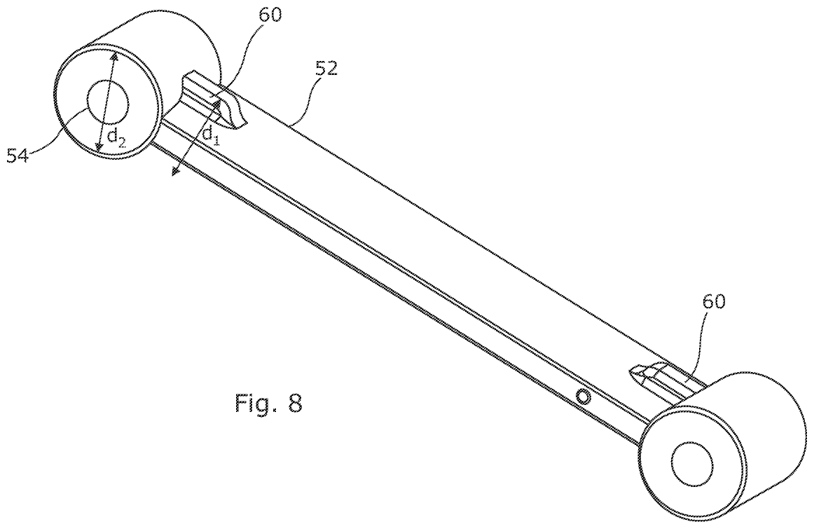

FIG. 8 shows a link in accordance with a second embodiment of the invention; and

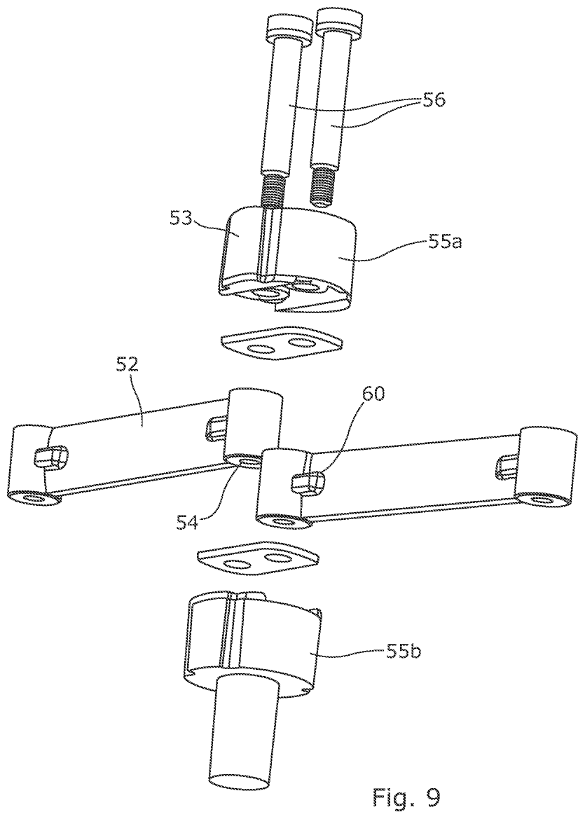

FIG. 9 shows a joint and two links of the second embodiment of FIG. 8.

In a first embodiment of the invention shown in the accompanying drawings, a chain 1 is formed of a plurality of links 2 joined together by joints 3. Each link 2 is of the form of an elongate rod having a through bore 4 perpendicular to its length at either end.

Each joint 3 is formed of a two-piece body 5a, 5b which supports two parallel shafts 6. Each shaft passes through the through bore 4 of one link 2, such that each joint 3 joins two successive links of the chain. Each joint 3 is therefore such that each link 2 attached to it can pivot about the shaft 6 which attaches it to the joint 3.

Each link 2 is, as noted above, generally elongate. Over most of the length, between each end, of each link 2, the link 2 has a first width d₁. As such, the cross section of the link 2 between the ends is generally constantly rectangular. However, at each end, about the through bores 4, each link 2 has a greater width d₂. This is of the form of a cylindrical section co-axial with the through bore 4.

The effect of this arrangement can be seen in FIG. 7 of the accompanying drawings. In this drawing, the chain 1 of links 2 moves from tension at the left into compression at the right.

When the chain is in tension, each joint 3 and its links 2 will adopt a first position where the distance l₁ between successive matching ones of the shafts 6 (in this example, the shaft in the left-most position in the chain 1)—the pitch—is at a maximum. As the tension reduces and is replaced by compression, the joints 3 will rotate relative to the links 2 such that the distance between the matching shafts in each successive joint 3—the pitch—is a lower value l₂.

Varying the pitch of the chain is useful, as it allows, for example, buckets of a conveyor to be brought closer together in a loading area (so as to avoid the contents being deposited into the buckets spilling through the gaps in the buckets) but separating the buckets so that they do not collide when the chain passes around corners.

The relative values of the first and second widths (and the spacing between the shafts 6 in the joints 3) will control the variation in the pitch between the first and second positions. In the first position, the pitch will be the sum of the distance between the centres of the through bores in one link 2 and the distance between the centres of the shafts 6 in one joint 3. In the second position, the bigger the difference between the first and second widths will allow a greater difference in the pitches.

Each joint 3, or a subset of them, can be provided with a trunnion 7 by means of which the chain can be driven. The joints 3 may support anything that the chain is to drive, for example a set of buckets.

Each of the two parts of the body 5a, 5b will largely be cylindrical and as such have a curved outer surface. In order to control the rotation of the joint 3 relative to the links 2, each of the two parts 5a, 5b can be provided with a pair of depressions 8 in the curved outer surface surrounding a central tab 9. As such, rather than relying on the user of applying tension or compression to the chain, the rotation of the joints 3 relative to the links 2 can be achieved by engaging the depressions 8 and tabs 9.

The joints 3 and links 2 can be made of any suitable material. However, each of the cylindrical bodies 5a, 5b of each joint 3 may comprise a load plate 10, which can be made of a stronger material than the rest of the body 5a, 5b. Typically, the body 5a, 5b can be made from a plastics/polymer material such as Nylon whereas the load plate could comprise a metal material such as steel.

Each load plate 10 comprises a plate having through bores 11 to match the spacing of the shafts 6. As such, rather than the tension or compression of the chain primarily passing through the body 5a, 5b, via the shafts 6, the load will pass through the shafts 6 through the load plate 10. This allows more load to be passed through each joint 3, without having to form the whole joint from a strong material.

Each link 2 may be formed of plastic or steel (depending on desired operating characteristics), although it may be reinforced by a plate of stronger material (e.g. steel) running along its length between the through bores 4.

A second embodiment of the invention is shown in FIGS. 8 and 9 of the accompanying drawings. In this embodiment, corresponding features to those of the first embodiment are shown with corresponding reference numerals, raised by 50.

In this embodiment, a chain is formed of a plurality of links 52 joined together by joints 53. Each link 52 is of the form of an elongate rod having a through bore 54 perpendicular to its length at either end.

Each joint 53 is formed of a two-piece body 55a, 55b which supports two parallel shafts 56. Each shaft passes through the through bore 54 of one link 52, such that each joint 53 joins two successive links 52 of the chain. Each joint 53 is therefore such that each link 52 attached to it can pivot about the shaft 56 which attaches it to the joint 53.

Each link 52 is, as noted above, generally elongate. Whereas the first width d₁ was present over most of the length of the link in the first embodiment, in this embodiment the first width is only present at a protrusion 60 at each end of the link, adjacent to each end (and not extending the whole depth of the link 52). At each end, about the through bores 54, each link 52 has a greater width d₂. This is of the form of a cylindrical section co-axial with the through bore 54. The width on the rest of the body of the link 52 is less than either d₁ or d₂, thus reducing the amount of material required.

The operation of the chain formed of the joints 53 and links 52 of this embodiment is similar to that of the first embodiment. When the chain is in tension, each joint 53 and its links 52 will adopt a first position where the distance l₁ between successive matching ones of the shafts 6—the pitch—is at a maximum. As the tension reduces and is replaced by compression, the joints 3 will rotate relative to the links 2 such that the distance between the matching shafts in each successive joint 3—the pitch—is a lower value l₂. This is dependent upon the interaction between the protrusion 60 and the cylindrical section around the bore 54.

1. A link for a chain, the link comprising a body defining first and second parallel through bores separated by a length, in which the body has a first width perpendicular to the length over at least a portion of the body adjacent to each bore and a second width through each bore parallel to the first width and perpendicular to the length, in which the first and second widths are different.

2. The link of claim 1, having the first width over the body except around each bore, and as such the portion of the body having the first width may have a consistent cross section along the length.

3. The link of claim 1, in which the first width is present only over part of the link, and comprises a protrusion from the body.

4. The link of claim 3, in which the body of the link has a width that is a maximum of a third width, narrower than the first or second widths, over at least part of the link.

5. The link of claim 4, in which the body of the link has the width that is a maximum of the third width over a majority of the length of the link.

6. The link of claim 3, in which the protrusion extends only over a portion of the depth of the link, perpendicular to the length and width of the link; the portion of the depth of the link typically being less than two thirds or a half of a maximum depth of the link.

7. The link of claim 1, in which each bore is cylindrical, having an axis and the body has an enlarged section around each bore having a part-cylindrical outer surface coaxial with the bore, with the second width being the diameter of the enlarged section.

8. A chain, comprising a plurality of links in accordance with any preceding claim, the links being joined successively in a chain, and a plurality of joints, each joint joining a pair of successive links, each joint comprising a body and two shafts, the body supporting the two shafts, with each shaft engaging the first bore of one of the pair of links and the second bore of the other of the pair of links, the joint being arranged such that it can rotate relative to each of the of the pair of links about the shaft which engages each link.

9. The chain of claim 8, in which the links are identically shaped.

10. The chain of claim 8, in which each joint has a first position relative to the pair of links in which an effective length being the distance between the first bores of each of the pair of links is maximised and a second position where the effective length is minimised, with rotation of the joint relative to each of the pair of links effecting a transition between the first and second positions.

11. The chain of claim 10, in which the first position is with the lengths of the pair of links co-linear.

12. The chain of claim 10, in which the second position is with a portion of the first link of the first width touching a portion of the second link with the second width and with a portion of the first link of the second width touching a portion of the second link with the first width.

13. The chain of claim 8, in which the chain is arranged such that placing a portion of the chain comprising a plurality of links in tension tends to cause joints in that portion to assume the first position and/or that placing a portion of the chain comprising a plurality of links in compression tends to cause joints in that portion to assume the second position.

14. The chain of claim 8, in which the shafts of each link are parallel.

15. The chain of claim 8, in which the shafts of each link are mounted in the body so as to pivot about at least one, and typically two, axes perpendicular to each shaft over a range of angles including the position where the shafts of each link are parallel.

16. The chain of claim 8, in which at least one of the joints comprises a trunnion by means of which the chain can be driven along its length.

17. The chain of claim 8, in which the body is generally cylindrical in shape having a curved outer surface, but has a deviation from cylindrical by means of which the joint can be rotated relative to its links.

18. The chain of claim 8, in which the body is provided with a load plate having a bore for each shaft, positioned in the body such that each shaft passes through a bore in the body and the load plate, and such that any compressive or tension load in the chain is passed between the shafts preferentially or entirely through the load plate rather than the body.

19. The chain of claim 18, in which the load plate is formed of a stronger (in terms of at least one of tensile strength and compressive strength) material than the body.
